(19) United States
(12) Patent Application Publication
(10) Pub. No.: US 2020/0265194 A1
(43) Pub. Date: Aug. 20, 2020

(54) INFORMATION PROCESSING DEVICE AND COMPUTER PROGRAM PRODUCT

(71) Applicant: FUJITSU CLIENT COMPUTING LIMITED, Kanagawa (JP)

(72) Inventor: Toshiro Ohbitsu, Kawasaki (JP)

(73) Assignee: FUJITSU CLIENT COMPUTING LIMITED, Kanagawa (JP)

(21) Appl. No.: 16/727,461

(22) Filed: Dec. 26, 2019

(30) Foreign Application Priority Data
Feb. 19, 2019 (JP) 2019-027822

(51) Int. Cl. G06F 40/30; H04L 12/58; G06F 40/279

(52) U.S. Cl. CPC G06F 40/30; H04L 51/04; H04L 51/32; H04L 51/02; G06F 40/279

(57) ABSTRACT

An information processing device includes processing circuitry. The processing circuitry implements a determination unit and a response unit. The determination unit determines, based on a word included in a conversation by a plurality of users, whether the conversation satisfies a predetermined intervention condition. The response outputs a response to change the conversation to a state different from a current state in response to a determination that the conversation satisfies the predetermined intervention condition.

### CROSS-REFERENCE TO RELATED APPLICATIONS

This application is based upon and claims the benefit of priority from Japanese Patent Application No. 2019-027822, filed Feb. 19, 2019, the entire contents of which are incorporated herein by reference.

### FIELD

The present disclosure relates generally to an information processing device and a computer program product.

### BACKGROUND

Technologies have conventionally been used in which a plurality of users perform communication in real time, such as chatting, in a social networking service (SNS) or the like.

Technologies have also been disclosed in which a computer program that automatically performs communication in place of a person responds to users using texts or voices. For example, technologies, such as a chatbot, are known that conduct a conversation with a user using texts.

### SUMMARY

According to an aspect of the present invention, an information processing device includes processing circuitry. The processing circuitry configured to implement a determination unit and a response unit. The determination unit is configured to determine, based on a word included in a conversation by a plurality of users, whether the conversation satisfies a predetermined intervention condition. The response unit is configured to output a response to change the conversation to a state different from a current state in response to a determination that the conversation satisfies the predetermined intervention condition.

According to another aspect of the present invention, a computer program product for information processing includes programmed instructions embodied in and stored on a non-transitory computer readable medium. The instructions, when executed by a computer, cause the computer to perform: determining, based on words included in a conversation by a plurality of users, whether the conversation satisfies a predetermined intervention condition; and outputting a response to change the conversation to a state different from a current state in response to a determination that the conversation satisfies the predetermined intervention condition.

### BRIEF DESCRIPTION OF THE DRAWINGS

FIG. 1 is a diagram illustrating an example of an overall configuration of a chat system according to a first embodiment of the present invention;

FIG. 2 is a chart illustrating an example of registrant information according to the first embodiment;

FIG. 3 is a chart illustrating an example of state identification information according to the first embodiment;

FIG. 4 is a chart illustrating an example of response type information according to the first embodiment;

FIG. 5 is a chart illustrating an example of response content information according to the first embodiment;

FIG. 6 is a flowchart illustrating an example of a flow of response processing according to the first embodiment;

FIG. 7 is an example of a chat by a plurality of users according to the first embodiment; and

FIG. 8 is a flowchart illustrating an example of a flow of response processing according to a second embodiment of the present invention.

### DETAILED DESCRIPTION

### First Embodiment

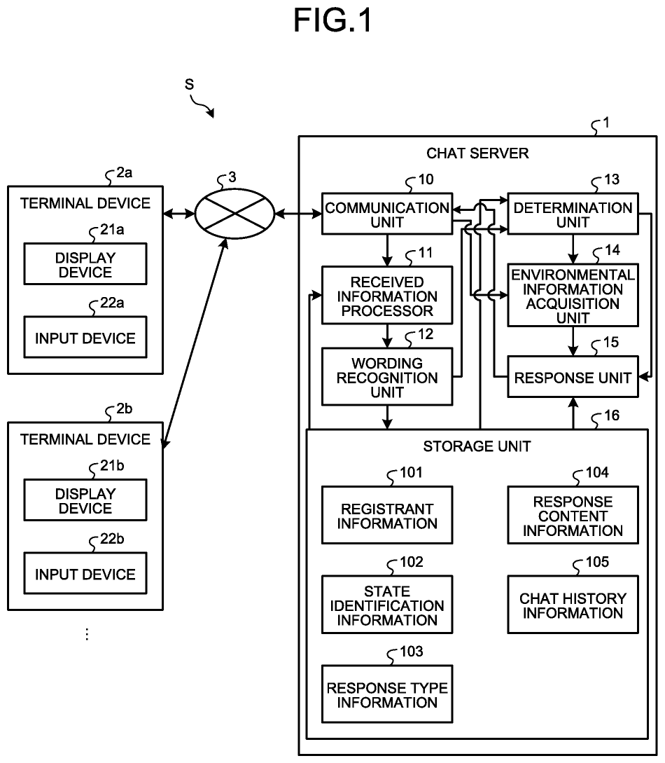

FIG. 1 is a diagram illustrating an example of an overall configuration of a chat system S according to a first embodiment of the present invention. As illustrated in FIG. 1, the chat system S includes a chat server 1 and a plurality of terminal devices 2a and 2b.

The terminal devices 2a and 2b are, for example, personal computers (PCs), smartphones, or tablet computers. Hereinafter, the terminal device 2a and the terminal device 2b will be simply called terminal devices 2 when they are not distinguished from each other. The number of the terminal devices 2 included in the chat system S is not limited. The terminal devices 2 include control devices such as central processing units (CPUs), storage devices such as read-only memories (ROMs) and random access memories (RAMs), external storage devices such as hard disk drives (HDDs) or flash memories, display devices 21a and 21b (hereinafter, simply called display devices 21 when they are not distinguished from each other), and input devices 22a and 22b (hereinafter, simply called input devices 22 when they are not distinguished from each other), and have a hardware configuration using ordinary computers. The display devices 21 are, for example, display equipment, and are also called display units. The input devices 22 are, for example, keyboards, mice, or touchscreen panels, and are also called operation units.

The chat server 1 is a server device connectable to the terminal devices 2 through a network 3 such as the Internet. The chat server 1 includes a control device such as a CPU, storage devices such as a ROM and a RAM, and an external storage device such as an HDD or a flash memory, and has a hardware configuration using an ordinary computer. The chat server 1 is an example of an information processing device in the present embodiment.

The chat server 1 can provide a chat service to a user of each of the terminal devices 2. Specifically, in the chat system S of the present embodiment, the user of each of the terminal devices 2 conducts a conversation with the chat server 1 using texts. In the present embodiment, the simple expression of “conversation” refers to a conversation through texts, that is, a conversation in a text chat through the network 3. Hereinafter, the term “text chat” will be simply called “chat”.

The following describes a functional configuration of the chat server 1. The chat server 1 includes a communication unit 10, a received information processor 11, a wording recognition unit 12, a determination unit 13, an environmental information acquisition unit 14, a response unit 15, and a storage unit 16.

The storage unit 16 stores registrant information 101, state identification information 102, response type information 103, response content information 104, and chat history information 105. The storage unit 16 is, for example, the storage device such as the HDD.

The registrant information 101 is information on the users who use the chat service, and is used as authentication information at the time of login of each of the users.

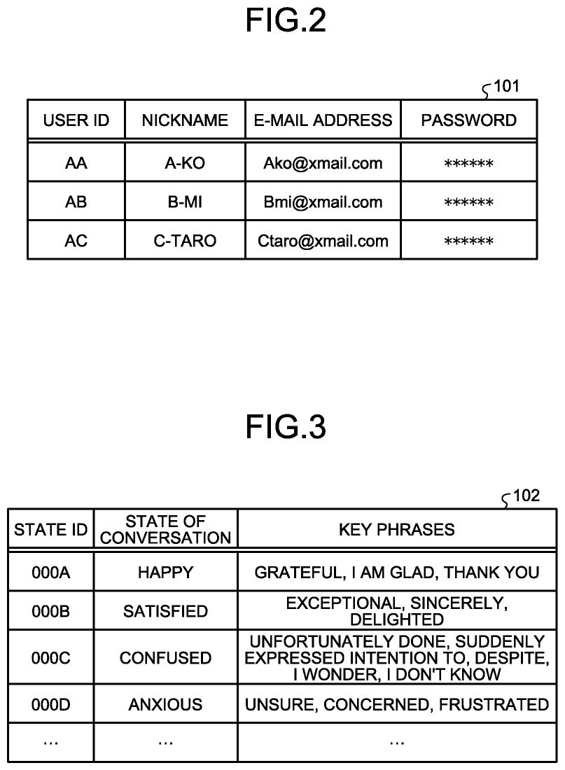

FIG. 2 is a chart illustrating an example of the registrant information 101 according to the present embodiment. As illustrated in FIG. 2, the registrant information 101 is information in which, for example, a user identifier (ID) capable of identifying a user is associated with, for example, a nickname, an e-mail address, and a password of the user. The registrant information 101 in FIG. 2 is merely an example. The registrant information 101 may further include information such as an address of the user.

FIG. 3 is a chart illustrating an example of the state identification information 102 according to the present embodiment. As illustrated in FIG. 3, the state identification information 102 is information in which a state ID is associated with a state of the conversation and one or more keywords.

The state of the conversation is a state of the conversation among a plurality of users participating in the chat, and is also called an atmosphere of the conversation. In the present embodiment, the state of the conversation is a classification of a character of an emotion of the users participating in the chat into, for example, “happy”, “satisfied”, “confused”, and “anxious”.

The state ID is identification information identifying a current state of the conversation.

The keywords are characteristic words uttered by the users in each of a plurality of states of conversation. For example, in the example illustrated in FIG. 3, keywords such as “unfortunately done”, “suddenly expressed intention to”, “regardless of”, “I wonder”, and “I don't know” are associated with the state of the conversation “confused”. The identification information for the state of the conversation “confused” is the state ID “000C”.

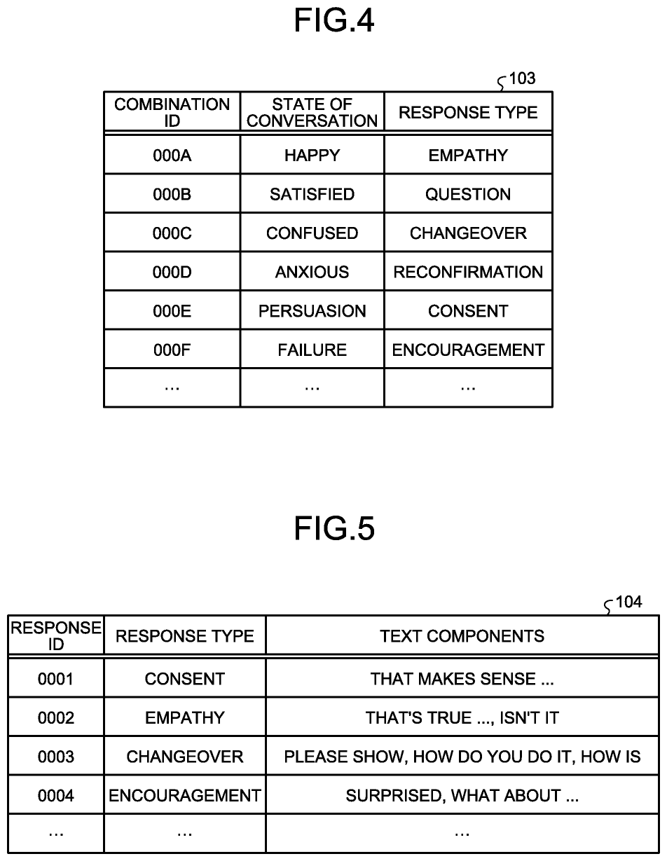

FIG. 4 is a chart illustrating an example of the response type information 103 according to the present embodiment. As illustrated in FIG. 4, the response type information 103 is information in which a combination ID is associated with the state of the conversation and the response type.

The combination ID is identification information identifying a combination of the state of the conversation and the response type. In FIG. 4, the state of the conversation is combined one-to-one with the response type. However, a plurality of states of conversation may be associated with each response type, or each state of the conversation may be associated with a plurality of response types.

The response type is a type of a response for the chat server 1 to change the current state of the conversation. For example, in the example illustrated in FIG. 4, if the current state of the conversation is “confused”, the type of the response for changing the state of the conversation is “changeover”. For example, if the current state of the conversation is “satisfied”, the type of the response for changing the state of the conversation is “question”.

FIG. 5 is a chart illustrating an example of the response content information 104 according to the present embodiment. As illustrated in FIG. 5, the response content information 104 is information in which a response ID is associated with the response type and text components. The response ID is identification information identifying the response type. The text components are components included in a text output as a response by the chat server 1. For example, in the example illustrated in FIG. 5, the response type “changeover” is associated with components such as “please show”, “how do you do it?”, and “how is”.

The text components registered in the response content information 104 are examples of content of responses that can change the conversation to a state different from the current state.

Since the response type information 103 and the response content information 104 both include the response types, the states of conversation are associated with the response types and the text components. In the present embodiment, when the response type information 103 and the response content information 104 are generically called, they are called response information.

In the present embodiment, the response type information 103 and the response content information 104 have been described as individual information. However, the response type information 103 and the response content information 104 may be integrated in, for example, one database.

Referring back to FIG. 1, the chat history information 105 is information on which utterances of the users and the chat server 1 in the chat are registered in chronological order.

The communication unit 10 transmits and receives information to and from each of the terminal devices 2. For example, the communication unit 10 receives information, such as text information or image information, transmitted from each of the terminal devices 2. The communication unit 10 transmits the received information to the received information processor 11. The communication unit 10 transmits a response text generated by the response unit 15 (to be described later) to each of the terminal devices 2.

The received information processor 11 classifies the information received by the communication unit 10 from each of the terminal devices 2 into the image information and the text information. The received information processor 11 authenticates the user based on the password entered by the user of each of the terminal devices 2 serving as a transmitter of the information and the information on the user registered in the registrant information 101.

If the user has been authenticated and the information received by the communication unit 10 from the terminal device 2 is the text information, the received information processor 11 transmits the received information to the wording recognition unit 12.

The wording recognition unit 12 analyzes the syntax of the text information received by the communication unit 10 from the terminal device 2, and recognizes the text information as wording. In the present embodiment, the wording may be a text including, for example, a subject and a predicate, or may be merely one or more words. The wording recognition unit 12 transmits the recognition result of the wording to the determination unit 13. The wording recognition unit 12 also registers the recognition result of the wording on the chat history information 105 in association with the user ID of the user as an utterer and a transmission time of the utterance.

The determination unit 13 determines, based on the words included in the conversation by the users, whether the conversation satisfies a predetermined intervention condition.

The predetermined intervention condition is a condition for the chat server 1 to intervene in the conversation by the users. In the present embodiment, the predetermined intervention condition includes two conditions, of which a first intervention condition is that a word included in the conversation matches with at least one of a plurality of preset keywords, and a second intervention condition is that a no-response period has continued for a predetermined time or longer during which none of the users participating in the chat has responded. In the present embodiment, the determination unit 13 determines that the predetermined intervention condition is satisfied if the conversation satisfies both the first intervention condition and the second intervention condition. The case where the conversation satisfies the first intervention condition and the second intervention condition is a case where the conversation among the users is not smoothly progressing, and is a case where the chat server 1 is desirable to intervene to change the state of the conversation.

Specifically, the determination unit 13 determines that the conversation satisfies the first intervention condition if a word included in the conversation matches with at least one of the preset keywords. The preset keywords are the keywords registered in the state identification information 102.

The determination unit 13 determines that the conversation satisfies the second intervention condition if the no-response period has continued for the predetermined time or longer during which none of the users participating in the chat has responded. The length of the predetermined time is not limited.

The last utterance before the no-response period serves as a target of the determination of the state of the conversation. The determination unit 13 determines whether the conversation satisfies the first intervention condition, based on the words included in the last utterance before the no-response period in the conversation by the users.

If the determination unit 13 determines that a word included in the last utterance before the no-response period matches with any one of the keywords registered in the state identification information 102, the determination unit 13 determines that the current state of the conversation is a state of the conversation associated with the keyword. If the determination unit 13 determines that more than one words included in the last utterance before the no-response period match with respective more than one of the keywords registered in the state identification information 102, the determination unit 13 determines that the current state of the conversation is a state of the conversation including the largest number of keywords matching with the word included in the last utterance before the no-response period, as an example. The determination unit 13 transmits the determined state of the conversation to the response unit 15. If the determination unit 13 determines that the conversation satisfies the first intervention condition and the second intervention condition, the determination unit 13 notifies the environmental information acquisition unit 14 that the conversation satisfies the predetermined intervention condition.

The environmental information acquisition unit 14 acquires various types of environmental information from, for example, an external device through the network 3 and the communication unit 10. In the present embodiment, various types of information other than the information transmitted as the utterances in the chat from the terminal devices 2 are called the environmental information. The environmental information is, for example, weather, temperature, and time, but is not limited thereto. The environmental information acquisition unit 14 may acquire, for example, current positions of the terminal devices 2 as the environmental information based on access information of the terminal devices 2. If the environmental information acquisition unit 14 is notified by the determination unit 13 that the conversation satisfies the predetermined intervention condition, the environmental information acquisition unit 14 acquires the environmental information, and transmits the acquired environmental information to the response unit 15.

The response unit 15 generates the response text to be provided as a response to the conversation by the users, and outputs the response text to the terminal devices 2 through the communication unit 10. Specifically, if the determination unit 13 determines that the current conversation satisfies the predetermined intervention condition, the response unit 15 outputs a response for changing the conversation to a state different from the current state. The content of the response provided by the response unit 15 is for suggesting or proposing a flow of the conversation to the participants of the chat, and therefore is also called advice for the conversation.

For example, the response unit 15 searches the response type information 103 for a response type associated with the state of the conversation determined by the determination unit 13. The response unit 15 also searches the response content information 104 for text components associated with the found response type. The response unit 15 generates the response text based on the text components found from the response content information 104, the environmental information acquired from the environmental information acquisition unit 14, and the past utterances of the users registered in the chat history information 105. A known technology, such as a chatbot, may be employed to generate the response text.

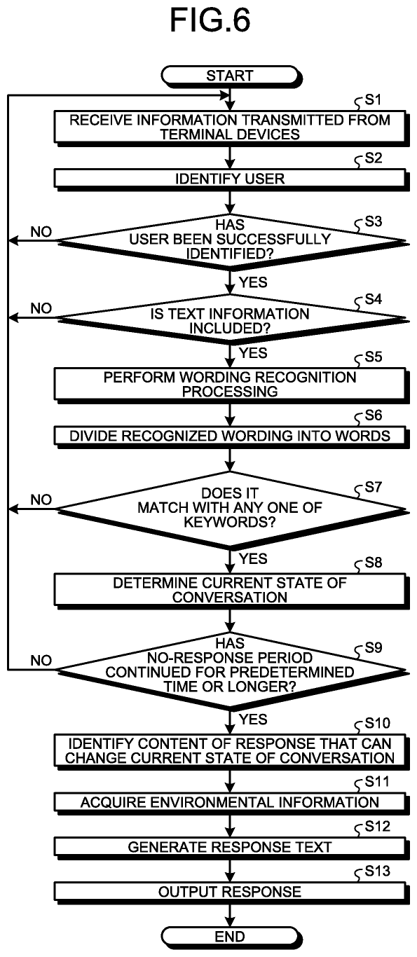

The following describes a flow of response processing executed on the chat server 1 of the present embodiment configured as described above. FIG. 6 is a flowchart illustrating an example of the flow of the response processing according to the present embodiment.

First, the communication unit 10 receives information transmitted from the terminal devices 2 (S1). The communication unit 10 transmits the received information to the received information processor 11.

Then, the received information processor 11 identifies a user who has entered the information received by the communication unit 10 from one of the terminal devices 2 into the terminal device 2 (S2). For example, when the users log in to participate in the chat, the received information processor 11 authenticates each of the users based on the password entered by the user of the terminal device 2 serving as a transmitter of the information and the information on the user registered in the registrant information 101. If the users have already logged in, the received information processor 11 identifies a user who has entered the information based on, for example, the terminal device 2 used by the user, each time the communication unit 10 receives information from the terminal devices 2.

The received information processor 11 determines whether the user has been successfully identified (S3). For example, if the user who has entered the information received by the communication unit 10 from one of the terminal devices 2 corresponds to none of the users registered in the registrant information 101, the received information processor 11 determines that the user has failed to be identified (No at S3). In the present embodiment, if the received information processor 11 cannot identify the user serving as the transmitter of the information, no response is made to the transmitted information, and therefore, the process returns to S1.

If the received information processor 11 tries to identify the user who has entered the information received by the communication unit 10 from one of the terminal devices 2 to be any one of the users registered in the registrant information 101, the received information processor 11 determines that the user has been successfully identified (Yes at S3).

In this case, the received information processor 11 determines whether the information received by the communication unit 10 from the terminal device 2 includes text information (S4). For example, if the information received by the communication unit 10 from the terminal device 2 includes only image information such as a photograph, the received information processor 11 determines that no text information is included (No at S4). In this case, the process returns to S1.

If the received information processor 11 determines that the information received by the communication unit 10 from the terminal device 2 includes the text information (Yes at S4), the received information processor 11 transmits the received information to the wording recognition unit 12.

The wording recognition unit 12 performs wording recognition processing of analyzing the syntax of the text information received by the communication unit 10 from the terminal device 2 to recognize the text information as wording (S5).

Then, the wording recognition unit 12 divides the recognized wording into words (S6). The wording recognition unit 12 transmits the recognition result of the wording divided into the words to the determination unit 13. The wording recognition unit 12 also registers the recognition result of the wording in the chat history information 105 in association with the user ID of the user as an utterer and a transmission time of the utterance.

Then, the determination unit 13 determines whether a word included in the wording recognized by the wording recognition unit 12 matches with any one of the keywords registered in the state identification information 102 (S7). If the determination unit 13 determines that a word included in the wording recognized by the wording recognition unit 12 matches with any one of the keywords registered in the state identification information 102, the determination unit 13 determines that the current state of the conversation is a state of the conversation associated with the keyword.

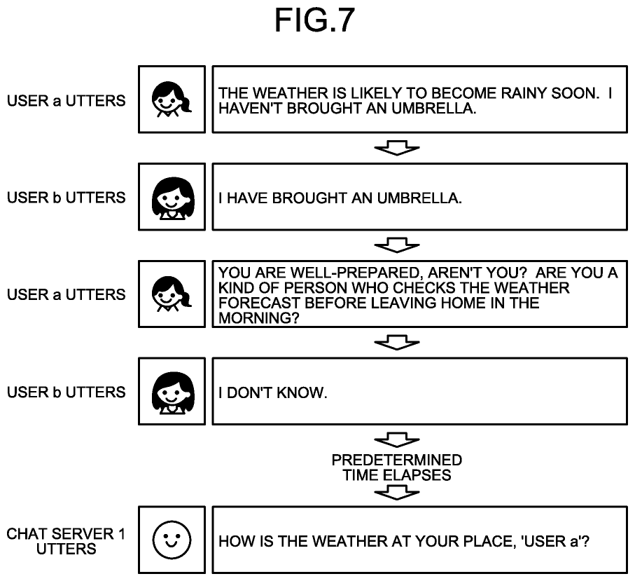

The text information entered by the users will be described by way of an example. FIG. 7 is an example of a chat by a plurality of users according to the present embodiment. In the example illustrated in FIG. 7, two users, that is, a user a and a user b are chatting.

For example, none of the keywords registered in the state identification information 102 is included in the first and second utterances of the user a and the first utterance of the user b. In such a case, the determination unit 13 determines that no word included in the wording recognized by the wording recognition unit 12 matches with any one of the keywords registered in the state identification information 102 (No at S7). In this case, the determination unit 13 determines that the conversation does not satisfy the first intervention condition, and the process returns to S1 to wait for the next utterance.

For example, the second utterance of the user b, “I don't know”, includes a keyword “I don't know” registered in the state identification information 102. In this case, the determination unit 13 determines that the word included in the wording recognized by the wording recognition unit 12 matches with “I don't know” among the keywords registered in the state identification information 102 (Yes at S7). In other words, in this case, the determination unit 13 determines that the conversation satisfies the first intervention condition.

The determination unit 13 determines that the current state of the conversation is a state of the conversation “confused” associated with the keyword “I don't know” in the state identification information 102 (S8).

Then, the determination unit 13 determines whether the no-response period has continued for the predetermined time or longer (S9). For example, after the determination unit 13 has determined whether an utterance of a user includes a keyword, if the next utterance begins before the predetermined time elapses from the transmission time of the utterance, the determination unit 13 determines that the no-response period has not continued for the predetermined time or longer (No at S9). In this case, the determination unit 13 determines that the conversation does not satisfy the second intervention condition, and the process returns to S1. In the present embodiment, if the no-response period has not continued for the predetermined time or longer, the conversation among the users continues. Therefore, the response by the chat server 1 is not applied to the conversation.

Even if the response by the chat server 1 is not applied to the conversation, the determination unit 13 may register the state ID corresponding to a determined state of the conversation in the chat history information 105 in association with the user ID of a user who has made an utterance.

In the example of the chat illustrated in FIG. 7, the no-response period in which neither the user a nor the user b makes an utterance continues for the predetermined time or longer after the second utterance of the user b, “I don't know”. The fact that the period continues in which neither of the users makes an utterance may mean that the conversation between the users is not smooth due to some cause. For example, in the example illustrated in FIG. 7, since the user a has asked the user b about a personal matter, the user b is confused, so that the conversation has paused. In this case, the user a may also be confused, being unable to determine how to answer to the user b. In such a case, the chat server 1 may assist the users to resume the conversation by changing the state of the conversation from the current state to a different state.

If the determination unit 13 determines that the no-response period has continued for the predetermined time or longer (Yes at S9), the determination unit 13 determines that the current state of the conversation satisfies the second intervention condition. In this case, the determination unit 13 outputs the determined state of the conversation as the current state of the conversation to the response unit 15. In other words, in the present embodiment, the determination unit 13 employs the state of the conversation determined based on the word included in the last utterance before the no-response period, as the current state of the conversation.

The response unit 15 identifies content of a response that can change the current state of the conversation (S10). Specifically, the response unit 15 searches the response type information 103 for a response type associated with the state of the conversation determined by the determination unit 13. In the example illustrated in FIG. 7, the response unit 15 identifies the response type “changeover” associated with the state of the conversation “confused” identified based on the second utterance of the user b that is the last utterance before the no-response period, as the response type of the response that can change the current state of the conversation. The response unit 15 searches the response content information 104 for text components associated with the identified response type “changeover”.

The environmental information acquisition unit 14 acquires the environmental information (S11). For example, the environmental information acquisition unit 14 acquires, for example, the current weather, temperature, time, and the current positions of the terminal devices 2 used by the users.

The response unit 15 generates the response text by adding a wording generated based on the environmental information acquired from the environmental information acquisition unit 14 and the information on the past utterances of the users registered in the chat history information 105 to the text components found from the response content information 104 (S12).

For example, in the example illustrated in FIG. 7, the history of the utterances of the user a and the user b includes terms “weather” and “weather forecast”. Thus, the response unit 15 determines to include “weather” in the response text. Since the last utterer before the no-response period is the user b, the response unit 15 determines that the user a cannot respond to the conversation. In this case, to prompt the user a to make an utterance, the response unit 15 determines to generate an interrogative sentence for the user a. The text components associated with the identified response type “changeover” among the text components registered in the response content information 104 are “please show”, “how do you do it?”, and “how is”.

In the example illustrated in FIG. 7, the response unit 15 selects “how is” from among the text components associated with the response type “changeover”. The response unit 15 understands, for example, from the information on the weather acquired as the environmental information, that the weather changes from the current time. In such a case, as an example, an interrogative sentence asking the situation of a change in the current weather is natural as a flow of conversation. Accordingly, in the example illustrated in FIG. 7, the response unit 15 generates a response text, “How is the weather at your place, ‘user a’?”. The response unit 15 changes the topic, and makes a response to prompt the user a to make an utterance. Thereby, the conversation between the users can be smoothly resumed.

The response unit 15 may further add information to the response text based on other environmental information. For example, the response unit 15 may generate a response text, for example, “The temperature has dropped to lower than that in the morning. How is the weather at your place, ‘user a’?” based on the information on the temperature. In this way, by generating the response text based on the environmental information, the response unit 15 can generate the natural response text hardly giving the other users (the user a and the user b) uncomfortable feeling. If the natural response text can be generated based on the text components registered in the response content information 104 and the information on the past utterances of the users registered in the chat history information 105 without using the environmental information, the response unit 15 need not use the environmental information.

The response unit 15 outputs the generated response text through the communication unit 10 to the terminal devices 2 (S13). The response text output from the communication unit 10 is transmitted through the network 3 to the terminal devices 2. The terminal devices 2 display the response text received from the chat server 1 on the display devices 21. The process of the flowchart ends.

As described above, the chat server 1 of the present embodiment determines, based on the words included in the conversation by the users, whether the conversation satisfies the predetermined conditions, and if so, outputs the response for changing the conversation to a state different from the current state. In other words, if the conversation among the users needs an intervention therein by the chat server 1, the chat server 1 of the present embodiment can output the response for changing the conversation to a state different from the current state to support a smooth progression of the conversation by the users.

If a word included in the conversation matches with at least one of the preset keywords, the chat server 1 of the present embodiment determines that the conversation satisfies the predetermined intervention condition. Therefore, in the state in which, according to the word included in the conversation of the users, an utterance in the current conversation suggests that the chat server 1 is desirable to intervene, the chat server 1 of the present embodiment can intervene in the conversation to change the state of the conversation.

More specifically, if a word included in the conversation matches with at least one of the preset keywords, and the no-response period has continued for the predetermined time or longer during which none of the users has responded, the chat server 1 of the present embodiment determines that the conversation satisfies the predetermined intervention condition. Therefore, if the conversation among the users has paused, the chat server 1 of the present embodiment can intervene in the conversation to change the state of the conversation.

The chat server 1 of the present embodiment determines the current state of the conversation based on the state identification information 102, and outputs the response based on the response type information 103 and the response content information 104. Therefore, the chat server 1 of the present embodiment can easily identify the current state of the conversation based on the word included in the conversation of the users, and can output the response that can change the conversation to a state different from the current state.

The chat server 1 of the present embodiment determines the state of the conversation based on the words included in the last utterance before the no-response period in the conversation by the users. If the users have made a plurality of utterances in the conversation in the chat, the cause of the pause of conversation is highly likely to be related to the last utterance before the start of the no-response period. Therefore, the chat server 1 of the present embodiment can appropriately understand the state of the conversation by determining the state of the conversation based on the words included in the last utterance before the no-response period.

The above description with reference to FIG. 7 has been made by way of the exemplary case where the state of the conversation is “confused”. However, the example to which the response by the chat server 1 is applied is not limited to this case. For example, if the state of the conversation is “happy”, the response unit 15 of the chat server 1 generates a text expressing “empathy” to an utterance of a user. For example, if the state of the conversation suggests that a user is “satisfied”, the response unit 15 of the chat server 1 generates a text that gives the user a “question” about details that the other users want to know or details that the satisfied user wants to talk about, the details being how the satisfaction has been obtained and what the content of the satisfaction is.

The content of the information listed in FIGS. 2 to 5 discussed above is merely an example, and is not limited thereto. The content of the state identification information 102, the response type information 103, and the response content information 104 is registered in advance by an administrator of the chat server 1. Alternatively, the administrator of the chat server 1 may periodically update the content of the state identification information 102, the response type information 103, and the response content information 104 based on the utterances of the users registered in the chat history information 105. The chat server 1 may automatically update the content of the state identification information 102, the response type information 103, and the response content information 104.

### Second Embodiment

In the first embodiment described above, the chat server 1 determines the state of the conversation based on the words included in the last utterance before the no-response period in the conversation by the users. In a second embodiment of the present invention, the state of the conversation is determined based on a further past utterance.

The overall configuration of the chat system S and the configurations of the chat server 1 and the terminal devices 2 according to the present embodiment are the same as those of the first embodiment. In the same way as in the first embodiment, the chat server 1 of the present embodiment includes the communication unit 10, the received information processor 11, the wording recognition unit 12, the determination unit 13, the environmental information acquisition unit 14, the response unit 15, and the storage unit 16. The communication unit 10, the received information processor 11, the wording recognition unit 12, the environmental information acquisition unit 14, the response unit 15, and the storage unit 16 have the same functions as those in the first embodiment.

The determination unit 13 of the present embodiment has the same function as that in the first embodiment, and in addition, determines the state of the conversation based on an utterance immediately before the last utterance if no word included in the last utterance before the no-response period matches with any one of the keywords.

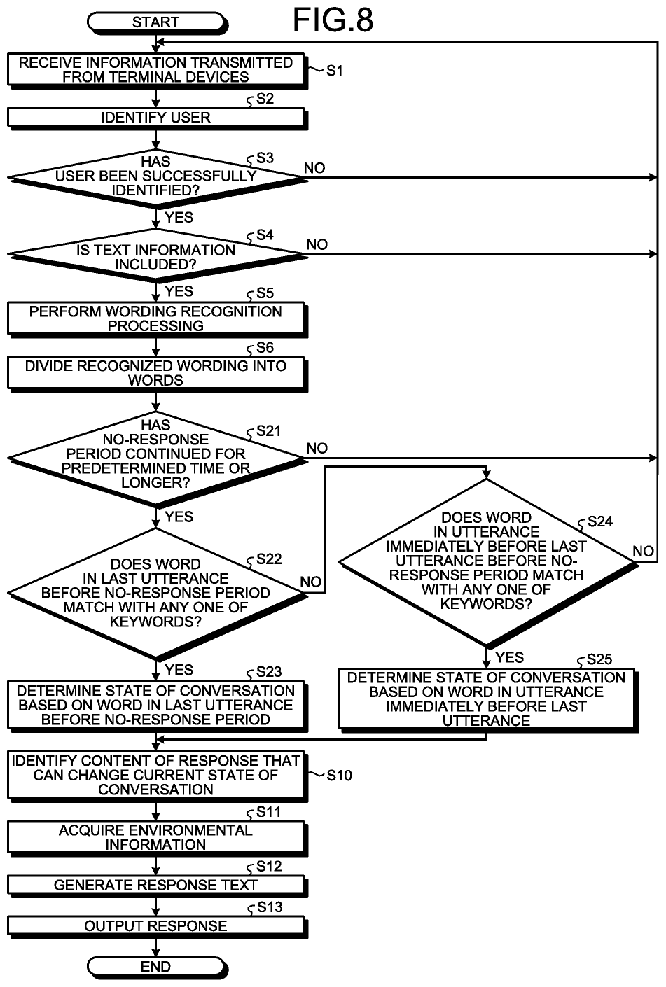

FIG. 8 is a flowchart illustrating an example of a flow of response processing according to the present embodiment. The processing from the reception of the information transmitted from the terminal devices 2 at S1 to the division of the recognized wording into the words at S6 is the same as the processing in the first embodiment described with reference to FIG. 6.

Subsequently, the determination unit 13 determines whether the no-response period has continued for the predetermined time or longer (S21). If not (No at S21), the determination unit 13 determines that the conversation does not satisfy the second intervention condition, and the process returns to S1.

If so (Yes at S21), the determination unit 13 determines that the current state of the conversation satisfies the second intervention condition. In this case, the determination unit 13 determines whether a word included in the last utterance before the no-response period matches with any one of the keywords registered in the state identification information 102 (S22).

If the determination unit 13 determines that a word included in the last utterance before the no-response period matches with at least one of the keywords registered in the state identification information 102 (Yes at S22), the determination unit 13 determines that the conversation satisfies the first intervention condition. In this case, the determination unit 13 determines the state of the conversation based on a word in the last utterance before the no-response period (S23). For example, the determination unit 13 determines that the current state of the conversation is a state of the conversation associated with the keyword in the state identification information 102 matching with the word in the last utterance before the no-response period.

If the determination unit 13 determines that no word included in the last utterance before the no-response period matches with any one of the keywords registered in the state identification information 102 (No at S22), the determination unit 13 determines whether a word in the utterance immediately before the last utterance before the no-response period matches with any one of the keywords (S24). Specifically, since the past utterances in the chat are registered in the chat history information 105, the determination unit 13 searches the chat history information 105 for the utterance immediately before the last utterance before the no-response period, and determines whether a word in the found utterance matches with any one of the keywords registered in the state identification information 102.

If the determination unit 13 determines that no word in the utterance immediately before the last utterance matches with any one of the keywords registered in the state identification information 102 (No at S24), the determination unit 13 determines that the conversation does not satisfy the first intervention condition, and the process returns to S1.

If the determination unit 13 determines that a word in the utterance immediately before the last utterance matches with at least one of the keywords registered in the state identification information 102 (Yes at S24), the determination unit 13 determines that the conversation satisfies the first intervention condition. In this case, the determination unit 13 determines the state of the conversation based on the word in the utterance immediately before the last utterance (S25). For example, the determination unit 13 determines that the current state of the conversation is a state of the conversation associated with the keyword in the state identification information 102 matching with the word in the utterance immediately before the last utterance before the no-response period.

The processing from the identification of the content of the response capable of changing the current state of the conversation at S10 to the response output at S13 is the same as that in the first embodiment.

As described above, the chat server 1 of the present embodiment determines whether a word included in the last utterance before the no-response period in the conversation by the user matches with at least one of the keywords, and if no word included in the last utterance matches with any one of the keywords, determines the state of the conversation based on the utterance immediately before the last utterance. Therefore, in addition to providing the effect of the first embodiment, the chat server 1 of the present embodiment can determine the state of the conversation based on the past utterances if the cause of the pause in the conversation among the users is not the utterance immediately before the pause. Therefore, the chat server 1 of the present embodiment can support the smooth progression of the conversation by the users in more situations.

In the present embodiment, the determination unit 13 determines the state of the conversation based on the utterance immediately before the last utterance before the no-response period, but may determine the state of the conversation based on an utterance earlier than the utterance immediately before the last utterance.

Modification 1

In the first and second embodiments described above, the input devices 22 are, for example, keyboards, mice, or touchscreen panels. However, the terminal devices 2 may each have a function of receiving a text through a voice. In this case, microphones capable of receiving voices of the users may be used as the input device 22.

Modification 2

In the first and second embodiments described above, the chat server 1 has been described to conduct the conversation through texts, that is, the conversation in the text chat with the users of the respective terminal devices 2. However, the chat server 1 may directly converse with the users through voice output. In this case, the response unit 15 of the chat server 1 may output the generated response text as a voice.

Modification 3

In the first and second embodiments described above, the determination unit 13 of the chat server 1 determines the state of the conversation based on the last utterance before the no-response period or the utterance immediately before the last utterance before the no-response period. However, the target of the determination is not limited to these utterances. For example, the determination unit 13 may individually determine the states of the users based on the respective utterances of the users participating in the chat. In this case, the determination unit 13 may determine the state of the conversation according to the states of individual users, instead of the state of the overall conversation.

For example, the determination unit 13 may determine the state of the conversation based on a word in past utterances of a user who has made the last utterance before the no-response period that matches with any one of the keywords registered in the state identification information 102. In other words, in the present modification, the state of the conversation is determined based on not only the last utterance before the no-response period or the utterance immediately before the last utterance before the no-response period, but also the past utterances of the user who has made the utterance.

Modification 4

The determination unit 13 of the chat server 1 may determine the state of the conversation based on a word or words frequently used in a plurality of utterances in the conversation. In the present modification, using the word or words included in not only one utterance but also a plurality of utterances as the target of the determination can more accurately identify the state of the conversation. Since the state of the conversation may change with lapse of time, the state of the conversation may be determined based on a plurality of past utterances in a certain period of time before the current time or the start of the no-response period.

As described above, the first and second embodiments can support the smooth progression of the conversation by the users.

A response processing program to be executed on the chat server 1 of the present embodiment is provided by being stored as a file in an installable format or an executable format on a computer-readable recording medium, such as a compact disc read-only memory (CD-ROM), a flexible disk (FD), a compact disc-recordable (CD), or a digital versatile disc (DVD).

The response processing program to be executed on the chat server 1 of the present embodiment may be stored on a computer connected to a network such as the Internet, and provided by being downloaded through the network. The response processing program to be executed on the chat server 1 of the present embodiment may be provided or distributed through the network such as the Internet. The response processing program of the present embodiment may be provided by being incorporated in advance in a ROM or the like.

The response processing program to be executed on the chat server 1 of the present embodiment has a modular configuration including the above-described units (the communication unit, the received information processor, the wording recognition unit, the determination unit, the environmental information acquisition unit, and the response unit). As actual hardware, a CPU (processor) reads the response processing program from the above-mentioned recording medium and executes it so as to load the above-listed units in a main memory, and thus generates the communication unit, the received information processor, the wording recognition unit, the determination unit, the environmental information acquisition unit, and the response unit in the main memory.

According to an embodiment, it is possible to support the smooth progression of the conversation by the users.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
processing circuitry that implements
a determination unit that determines, based on a word included in a conversation by a plurality of users, whether the conversation satisfies a predetermined intervention condition; and
a response unit that outputs a response to change the conversation to a state different from a current state in response to a determination that the conversation satisfies the predetermined intervention condition.

2. The information processing device according to claim 1, wherein the determination unit determines that the conversation satisfies the predetermined intervention condition when a word included in the conversation matches with at least one of a plurality of keywords set in advance.

3. The information processing device according to claim 2, wherein the determination unit determines that the conversation satisfies the predetermined intervention condition when a word included in the conversation matches with at least one of the plurality of keywords set in advance, and a no-response period during which none of the plurality of users responds continues for a predetermined time or longer.

4. The information processing device according to claim 3, wherein
the determination unit determines the current state of the conversation based on state identification information in which the plurality of keywords is associated with states of conversation in advance, and
the response unit outputs the response based on response information in which a current state of conversation is associated with content of a response that changes the conversation to a state different from the current state.

5. The information processing device according to claim 4, wherein the determination unit determines the current state of the conversation based on a word included in a last utterance before the no-response period in the conversation by the plurality of users.

6. The information processing device according to claim 4, wherein the determination unit determines whether a word included in a last utterance before the no-response period in the conversation by the plurality of users matches with at least one of the plurality of keywords, and when no word included in the last utterance matches with any one of the plurality of keywords, determines the current state of the conversation based on an utterance immediately before the last utterance.

7. A computer program product including programmed instructions embodied therein and stored on a non-transitory computer readable medium, the instructions cause the computer to:
determine, based on words included in a conversation by a plurality of users, whether the conversation satisfies a predetermined intervention condition; and
output a response to change the conversation to a state different from a current state in response to a determination that the conversation satisfies the predetermined intervention condition.
